(19) United States
(12) Patent Application Publication
(10) Pub. No.: US 2026/0124731 A1
(43) Pub. Date: May 7, 2026

(54) SYSTEMS AND METHODS FOR A POWER TOOL WITH A DUAL-FUNCTION RELIEF VALVE

(71) Applicant: Milwaukee Electric Tool Corporation, Brookfield, WI (US)

(72) Inventor: Harrison T. Snyder, Pewaukee, WI (US)

(21) Appl. No.: 19/381,537

(22) Filed: Nov. 6, 2025

Related U.S. Application Data
(60) Provisional application No. 63/717,045, filed on Nov. 6, 2024.

(51) Int. Cl. B25F 5/00; F16K 17/02

(52) U.S. Cl. CPC B25F 5/005; F16K 17/02

(57) ABSTRACT

A power tool includes a cylinder, a piston movable within the cylinder to define a fluid chamber within the cylinder, a reservoir to retain fluid, and a motor that is operable to drive a pump to supply fluid from the reservoir to the fluid chamber to extend the piston. The power tool further includes a relief valve that opens based on a pressure in the fluid chamber to allow fluid to drain from the fluid chamber to the reservoir. The relief valve is configured to open when a pressure in the fluid chamber reaches at predefined cracking pressure. A user interface is manually actuatable to open the relief valve independent of the pressure in the fluid chamber being at the predefined cracking pressure.

### CROSS-REFERENCE TO RELATED APPLICATIONS

This application claims the benefit of and priority to U.S. Provisional Patent Application No. 63/717,045, filed November 6, 2024, which is incorporated herein by reference in its entirety.

### BACKGROUND

Crimpers and cutters often include a crimping head with opposed jaws that include certain crimping and cutting features, depending on the particular configuration of the tool. Some crimpers and cutters are hydraulic power tools that include a piston that can exert force on the crimping or cutting head, which may be used for closing the jaws to perform crimp, compression, or cutting work at a targeted location. A valve can be used to relieve hydraulic pressure within a cylinder of the power tool.

### SUMMARY

In some aspects, a power tool can include a cylinder and a piston movable within the cylinder to define a fluid chamber within the cylinder. The power tool can include a reservoir to store a fluid. A motor can be operable to drive a pump to supply the fluid from the reservoir to the fluid chamber to extend the piston. A relief valve can open based on a pressure in the fluid chamber to allow fluid to drain from the fluid chamber to the reservoir. The relief valve can be configured to open when a pressure in the fluid chamber reaches at predefined cracking pressure. A first user interface can be manually actuatable to open the relief valve independent of the pressure in the fluid chamber being at the predefined cracking pressure.

In some examples, the relief valve can be positioned along a passageway that extends between the fluid chamber and the reservoir.

In some examples, the relief valve can include a poppet that moves between a closed position where the poppet is engaged with a seat defined in a valve body and an open position where the poppet is disengaged from the seat.

In some examples, the poppet can be biased to the closed position by a spring. The spring can have a pre-load corresponding to the predefined cracking pressure.

In some examples, actuation of the first user interface can cause the poppet to move from the closed position to an open position.

In some examples, the first user interface can be one of a switch, a slider, or a lever that applies an external force to the poppet.

In some examples, the power tool can include a pump coupled between the reservoir and the cylinder. A second user interface can be manually actuatable to cause the pump to supply fluid from the reservoir to fluid chamber in the cylinder to move the piston.

In some examples, the first user interface and the second user interface can be arranged for single-handed operation of the power tool.

In some examples, the poppet can be positioned in the pump.

In some examples, the poppet can be disposed in a valve body that is positioned in the pump.

In some examples, the second user interface can be a head of the poppet.

In some examples, the poppet can include a head and the second user interface can engage the head.

In some aspects, a dual-actuated relief valve can include a valve body defining a port. A valve element can be movable within the valve body between an open position where the valve element blocks the port and a closed position where the valve element opens the port. A biasing element can bias the valve element to the closed position and can be configured to allow the valve element to move to the open position based on a fluid pressure acting on the valve element. A user interface can be coupled to the valve element to allow a user to manually move the valve element from the closed position to the open position.

In some examples, the valve element can be a poppet that engage with a seat in the valve body in the closed position and disengages from the seat in the open position.

In some examples, the user interface can be a mechanical actuator that is moved by the user.

In some examples, the user interface can be an electronic actuator.

In some aspects, a method of operating a relief valve in a power tool can include providing a relief valve having a valve element movable between a closed position and an open position within a valve body. The method can include biasing the valve element toward the closed position with a biasing element. The method can include moving the valve element from the closed position to the open position when fluid pressure acting on the valve element reaches a predefined cracking pressure. The method can include actuating a first user interface to move the valve element from the closed position to the open position independent of the fluid pressure reaching the predefined cracking pressure.

In some examples, actuating the first user interface can include applying an external force to a plunger connected to the valve element.

In some examples, the method can include actuating a second user interface to operate a pump to supply fluid from a reservoir to a cylinder when the relief valve is in the closed position.

In some examples, the method can include discharging fluid through the relief valve when the valve element is in the open position to reduce pressure in a fluid chamber of the power tool.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of a hydraulic tool, according to an example embodiment;

FIG. 2 illustrates a block diagram of certain components of the hydraulic tool illustrated in FIG. 1;

FIG. 3 illustrates another block diagram of certain components of the hydraulic tool illustrated in FIG. 1;

FIG. 4 illustrates a cross-sectional view of the hydraulic tool illustrated in FIG. 1;

FIG. 5 illustrates an enlarged cross-sectional view of the hydraulic tool illustrated in FIG. 1, taken at area V-V of FIG. 4;

FIG. 6 illustrates an enlarged cross-sectional view of a relief valve of the hydraulic tool of FIG. 1, in a closed position.

FIG. 7 illustrates an enlarged cross-sectional view of the relief valve of FIG. 6, in an open position.

FIG. 8 illustrates an enlarged cross-sectional view of a relief valve of the hydraulic tool of FIG. 1, in a closed position.

FIG. 9 illustrates an enlarged cross-sectional view of the relief valve of FIG. 9, in an open position.

FIG. 10 illustrates an enlarged cross-sectional view of a relief valve of the hydraulic tool of FIG. 1, in a closed position.

FIG. 11 illustrates an enlarged cross-sectional view of the relief valve of FIG. 10, in an open position.

FIG. 12 illustrates a flowchart of an example crimping method utilizing a hydraulic tool, according to an example embodiment.

### DETAILED DESCRIPTION

Hydraulic tools can be used to perform cuts, crimps, or press work on a workpiece, such as on a pipe, a cable, or a connector, for example. Generally, hydraulic tools include a cylinder and piston configuration, where a piston is configured to extend and retract within a cylinder, and thus, move jaws, or any other implement coupled to the piston to perform a task (crimping, cutting, punching, etc.). Hydraulic fluid can be directed in and out of chambers of the cylinder and piston configuration to cause the piston to extend and retract. The hydraulic fluid can generally displace the cylinder or piston to actuate a work head to press, lift, crimp, cut, punch, or otherwise perform an action on a work piece retained.

Conventional hydraulic tools generally displace the cylinder or piston toward the work head until the work head contacts the workpiece retained within the work head. Once the work head contacts the workpiece, a hydraulic pressure within the cylinder of the workpiece may increase, so that the work head may exert a greater force on the work piece. The hydraulic pressure within the cylinder may continue to grow until achieving a relief pressure. Once the relief pressure is achieved an automatic relief valve releases the pressure within the cylinder and opens the work head or otherwise disengages the work head from the workpiece. In some applications, it may be desirable to disengage the work head from the workpiece prior to performing a task on the workpiece. For example, a user who has realized that the workpiece should not be cut, crimped, or otherwise altered at a specific location may wish to disengage the work head from the workpiece. In other examples, the tool may malfunction or lose power while the work head is engaged or otherwise locked on the work piece. Conventional, hydraulic tools may not include a mechanism to release hydraulic pressure within the cylinder prior to the automatic release of the automatic relief valve at the relief pressure. As such, there is a general need for a hydraulic tool that enables hydraulic pressure relief within the cylinder and disengagement of the work head from the workpiece.

Generally, a power tool (e.g., a hydraulic too) includes a pump, a piston, and a work head. The pump may supply one or more of a plurality of hydraulic fluid chambers to extend the piston and thus actuate the work head. The fluid supplied to the fluid chambers may act on the piston causing the piston to extend.

In some examples, the power tool includes a dual function relief valve that is both automatically actuatable in response to pressure in a hydraulic cylinder (e.g., as an emergency relief valve) and that is manually actuatable by a user (e.g., as a dump or release valve). That is, the relief valve is selectively actuatable by a user to reduce hydraulic pressure within the fluid chambers and thus disengage the work head from a workpiece. This gives a user additional control over tool operation, as compared with conventional designs where a work head may not be readily disengaged from a workpiece, especially during a loss of power or other malfunction of the tool. In accordance with aspects of the disclosure, the relief valve can be actuatable by the user to selectively allow fluid communication between the fluid chambers and the reservoir. Actuation of the relief valve may therefore allow retraction of the piston and may further disengage or retract the work head. Such “on-demand” actuation of the relief valve can be controlled by the user through an actuating element of the relief valve. Actuating elements can be manual actuating elements, for example, a button, lever, toggle, slide, etc., or electronic actuating elements, such as electrical switch or other control interface that can be coupled to, for example, a solenoid, linear actuator, etc. In some examples, the actuating elements may manually open the relief valve, ensuring the relief valve can be opened regardless of the operational status of the tool (e.g., powered on, powered off, malfunctioning, or other status).

Examples of the relief valve described herein include a valve assembly having valve body and a valve element (e.g. a poppet or another type of valve element) moveable within the valve body. The valve element can regulate fluid communication between the reservoir of the hydraulic tool and the fluid chambers. In use, the valve element can be biased toward a closed position by a biasing member (e.g., a spring). The valve element can be automatically actuated to an open position by a fluid pressure (e.g., from the pump), counteracting the force of the spring. For example, pressure within a cylinder of a power tool may reach a threshold pressure at which the valve element opens. The valve element can also be selectively actuated by the user to the open position by a lever, button, switch, slide, or other user interface. This allows the relief to provide dual function as a manual release valve (e.g., to manually cause retraction of a piston) and a dump valve (e.g., to automatically cause retraction of a piston upon complete of a work operation).

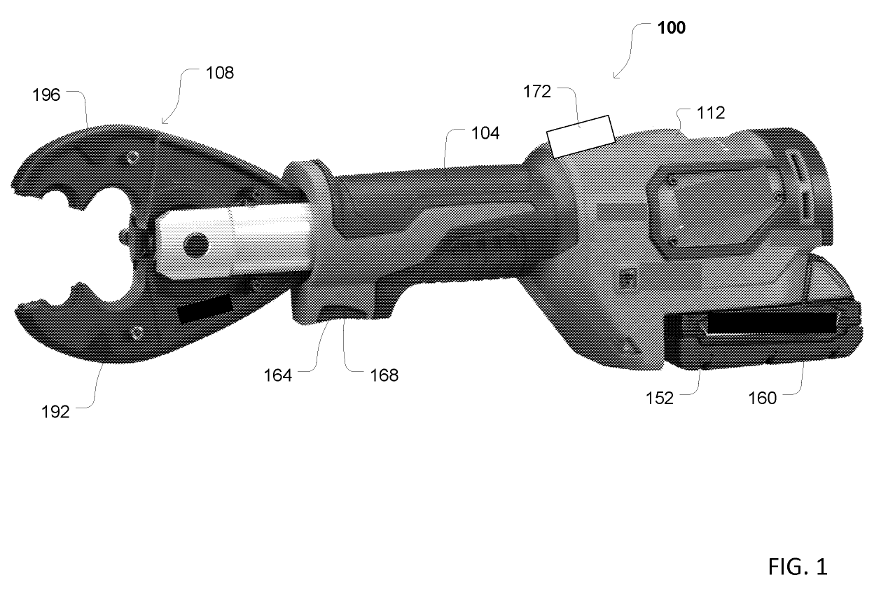

FIG. 1 illustrates a power tool 100, in accordance with aspects of the disclosure. Although the example implementation described herein depicts a crimping tool, it should be understood that the features of this disclosure can be implemented in other types of tools, such as cutting tools, punching tools, etc. In addition, any suitable size, shape or type of elements or materials could be used. As just one example, the illustrated power tool 100 includes a body 104 (e.g., a cylinder, a motor, a reservoir, electronics, etc.) and a work head 108. The body 104 can be disposed within a housing 112 and the work head 108 can extend from the housing 112 to engage with a workpiece. In the illustrated example, the work head 108 is a crimping head. However, alternative styled work heads may also be used for crimping, cutting, or punching, including, blades, jaws, crimping dies, etc.

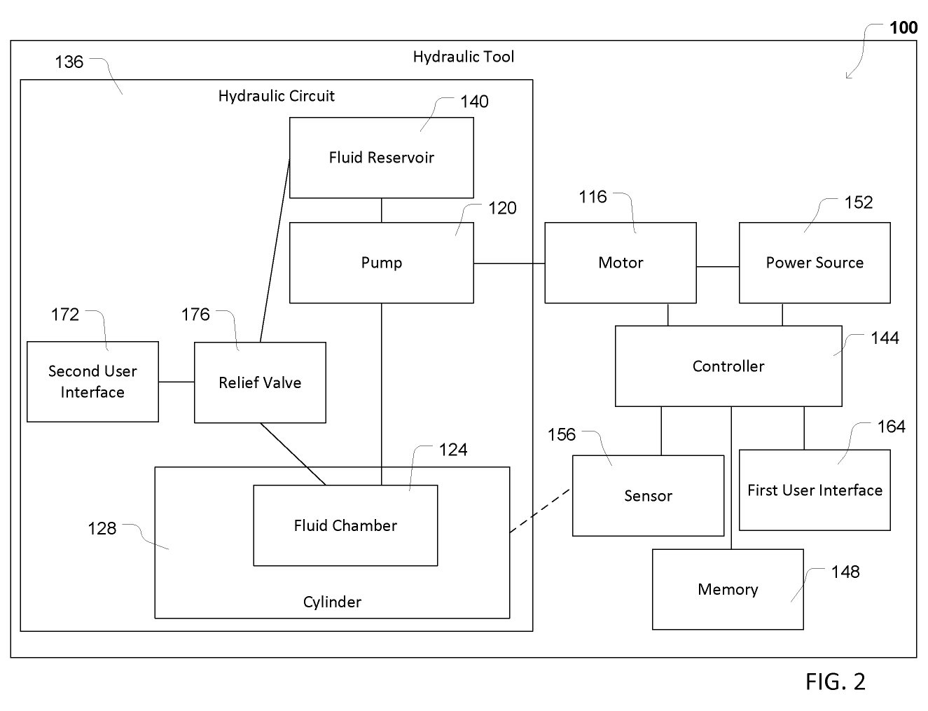

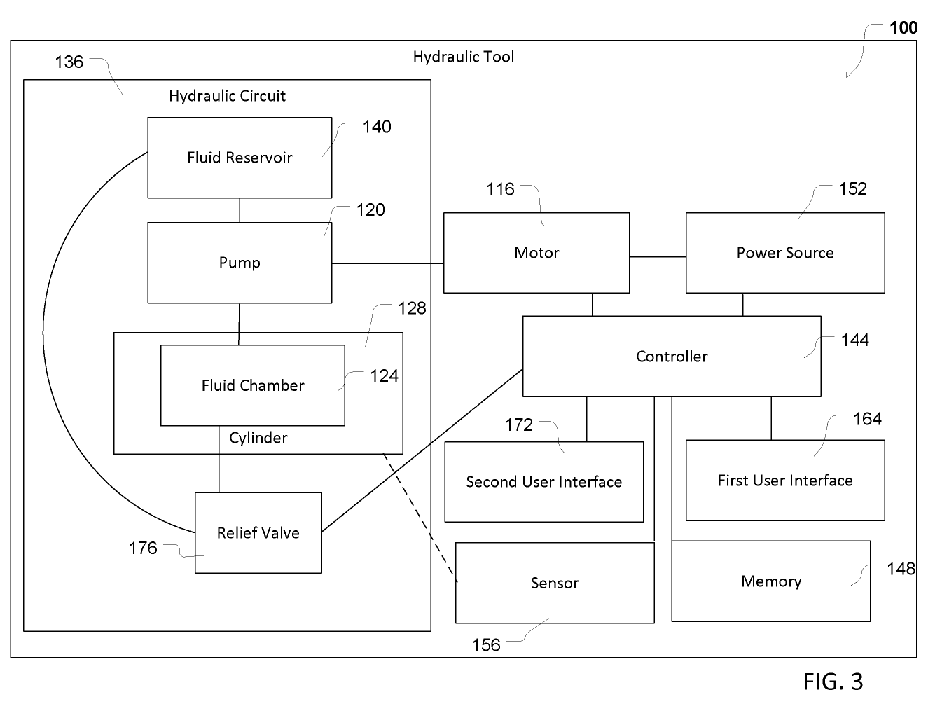

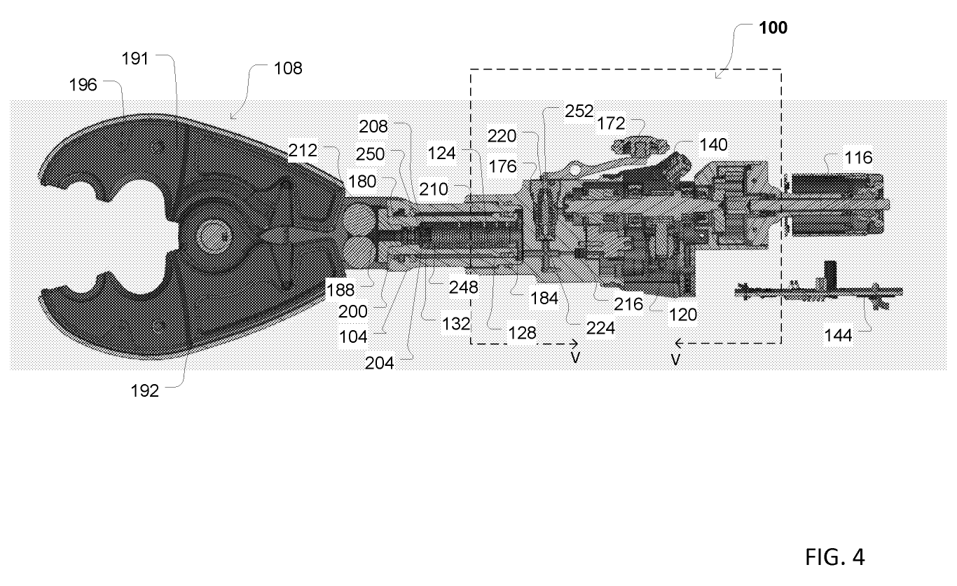

FIGS. 2 and 3 illustrate a block diagram of certain components of the power tool 100 illustrated in FIGS. 1, 4, and 5. As illustrated in FIG. 2, the power tool 100 includes a motor 116 configured to drive a pump 120. The pump 120 is configured to provide pressurized hydraulic fluid to an actuator. More specifically, the pump provides fluid to a fluid chamber 124 of a cylinder 128. A piston 132 is slidably accommodated within the cylinder 128 to define the fluid chamber (as shown in FIG. 4). For example, a hydraulic circuit 136 of the power tool 100 may connect a reservoir 140 to the pump 120, so that the pump 120 may supply fluid to a fluid chamber 124, and thus drive the piston 132 (as shown in FIG. 4). In some examples, the hydraulic circuit 136 may instead include a plurality of the fluid chambers 124 within the cylinder 128. For example, selectively supplying fluid to one or more of a plurality of the fluid chambers 124 (e.g., a first, second, or third fluid chamber) may modulate an actuation speed and actuation force of the piston 132 within the cylinder 128.

In some examples, functions of hydraulic tools can be controlled by a computing device. For example, the hydraulic tool can include a controller 144. The controller 144 may include a processor, a memory 148, and a communication interface. The memory 148 may include instructions that, when executed by the processor, cause the controller 144 to operate the power tool 100. In one arrangement, the controller communication interface enables the controller 144 to communicate with various components of the power tool 100 such as user interface components, the motor 116, memory 148, a power source 152, one or more sensors 156, and various components of the hydraulic circuit 136 (see, e.g., FIG. 3). The power source 152 may be a battery that may be removably connected to a portion of the hydraulic tool, such as a battery receptacle 160 of the housing 112 of the hydraulic tool. However, in other examples, other types of systems can be used to provide a pressurized flow of hydraulic fluid.

As illustrated in FIG. 2, the power tool 100 may include a user interface components that allow user inputs to the power tool 100. As will be described below, user interface components may be used to operate functions of the power tool 100.

For example, a first user interface component 164, here, shown as a trigger 168, may be actuatable to activate the motor 116 and therefore drive the piston 132. In some examples, the first user interface component 164 may be linked to the controller 144. For example, the trigger 168 can engage a switch coupled to the controller 144. In such examples, actuating the trigger 168 may cause the controller 144 to actuate the motor 116. In some cases, a first user interface component 164 may comprise other types of controls for a user, including for example, an operator panel, one or more switches, one or more push buttons, one or more interactive indicating lights, soft touch screens or panels, levers, slides and other types of similar switches such as a trigger switch.

During an example work operation, the user actuates the trigger 168 to initiate piston extension. The controller 144 activates the motor 116 in response to the trigger actuation. The motor 116 drives the pump 120 to supply pressurized fluid to the fluid chamber 124. The pressurized fluid acts on the piston 132, causing the piston 132 to extend or retract within the cylinder 128. As the piston 132 extends, the work head 108 moves toward a workpiece positioned between the jaws 192, 196.When the work head 108 contacts the workpiece, resistance increases. The pump 120 continues to supply fluid, building pressure within the fluid chamber 124. The increased pressure enables the work head 108 to apply greater force to the workpiece. The pressure continues to build until the workpiece is sufficiently crimped, cut, or punched. Upon completion of the work operation, the pressure reaches the predefined cracking pressure of a relief valve 176, as described in greater detail below. The relief valve 176 opens, allowing fluid to drain from the fluid chamber 124 to the reservoir 140. The return spring 248 then returns the piston 132 (e.g., via the other of extension or retraction), causing the work head 108 to disengage from the workpiece.

Still referring to FIG. 2, the power tool 100 may further include a second user interface 172. In some examples, the second user interface 172 may be actuatable to retract the piston 132 and therefore retract the work head 108, as shown in FIG. 4. Specifically, the second user interface 172 may be actuated to selectively open and close the relief valve 176 positioned between the reservoir 140 and the fluid chamber 124. As will be described further below, opening the relief valve 176 may cause the piston 132 and the work head 108 to retract (shown in FIG. 4). That is, opening the relief valve 176 can connect the cylinder 128 to the reservoir 140 to allow fluid to exit the cylinder and flow to the reservoir. In some cases, such as during pumping, the relief valve 176 can open to divert excess pump flow and prevent an overpressure condition.

As illustrated in FIG. 2, in some examples, the second user interface 172 may be physically connected to the relief valve 176 (directly or indirectly). For example, as described further below, the second user interface 172 may be a switch, lever, slide, or trigger that manually acts on a poppet of the relief valve 176 to move the relief valve 176 to an open position.

Referring briefly to FIG. 3, in some examples, the second user interface 172 may instead be linked to the controller 144. For example, as described further below, the second user interface 172 may be a switch, lever, slide, or trigger that when actuated may cause the controller 144 to actuate the relief valve 176 to the open position via a solenoid, a linear actuator, a motor, or some other type of actuator.

FIG. 4 provides an example implementation of a hydraulic circuit according to aspects of the invention. In this illustrated hydraulic tool example, the power tool 100 includes the cylinder 128. The piston 132 of the hydraulic actuator cylinder 128 has a first piston end 180 and a second piston end 184 opposite the first piston end 180. At the first piston end 180 the piston 132 is coupled to a link mechanism 188 that is configured to actuate the work head 108. Specifically, the piston 132 is configured to drive a work head 191, here configured as movable jaws 192, 196. The piston 132 can extend to drive the jaws 192, 196 toward one another to perform a task on a workpiece retained within the work head 108 (e.g., cutting, crimping, punching, or other work). When the piston 132 of the cylinder 128 is retracted, the moveable jaws 192, 196 may be opened or pulled back to a fully retracted or a home position as shown in FIGS. 1 and 4. Alternatively, the moveable jaws 192, 196 may be pulled back to a partially retracted position. In other examples, different types of work heads can be used, for example, cutters, punches, etc.

When pressurized fluid is provided to the cylinder 128 by way of the pump 120, the fluid acts on the piston 132 inside the cylinder 128, and causes the piston 132 to extend toward the workpiece within a work area of the work head 108. Specifically, the pressurized fluid is supplied into the fluid chamber 124 of the cylinder 128, and the fluid within the fluid chamber 124 may provide a force configured to extend the piston 132. As the piston 132 extends, the link mechanism 188 causes the moveable first and second moveable jaws 192, 196 to move toward one another, and may therefore cause the jaws 192, 196 to act upon a workpiece that has been placed between the jaws 192, 196. When the crimping, cutting, or punching operation is completed, the controller 144 can provide instructions to the hydraulic circuit 136 to stop the motor 116 and thereby release the high-pressure fluid back to a reservoir 140 as described in greater detail herein.

Referring still to FIG. 4, as described above, the piston 132 can be moveably accommodated within the cylinder 128. The piston 132 includes a piston head 200 and a piston rod 204 extending from the piston head 200 along a central axis direction of the cylinder 128 (e.g., an extension axis of the piston 132). As shown, the piston 132 can, in some examples, be partially hollow. Particularly, the piston rod 204 is at least partially hollow to form a cylindrical cavity 208 within the piston 132.

In some examples, the piston 132 can partition the cylinder 128 into the fluid chamber 124 (e.g., a first chamber) and a second chamber 210. For example, the second chamber 210 may be defined between an exterior wall of the piston 132 and an interior wall of the cylinder 128, such that the second chamber 210 extends circumferentially around the piston 132. In some examples, the piston 132 may be slidably accommodated within the second chamber 210. Additionally, the second chamber 210 may not retain hydraulic fluid.

In some examples, the fluid chamber 124 may be defined within the cylindrical cavity 208. The fluid chamber 124 may further be defined between the second piston end 184 and an end of the cylinder 128 opposite the work head 108, such that a volume of the fluid chamber 124 increases as the piston 132 is slidably moved toward the work head 108.

In some examples, the piston 132 may further include or may otherwise be coupled to a ram 212. As illustrated in FIG. 4, the ram 212 can actuate the moveable jaws 192, 196 via the link mechanism 188. Thus, movement of the piston 132 may drive the ram 212 to actuate the moveable jaws 192, 196.

The pump 120 is configured to draw fluid from the reservoir 140 to pressurize the fluid and deliver the fluid to the fluid chamber 124 of the cylinder 128 after a user initiates a work command. The work command may by initiated by the user entering a command on the user interface components (shown in FIG. 2). For example, a crimp command could be initiated by the user entering a crimp command by way of the first user interface component 164.

The reservoir 140 may include fluid at a pressure close to atmospheric pressure, e.g., a pressure of 15-20 pounds per square inch (psi). Initially, the pump 120 provides low pressure fluid to the cylinder 128. For example, the motor 116 may drive the pump 120 to provide fluid through a check valve 216 to the cylinder 128. The check valve 216 may ensure fluid delivered to the cylinder 128 does not return directly to the pump 120. Additionally, the fluid may be blocked from flowing into the reservoir 140 by a relief valve 176.

The fluid delivered to the fluid chamber 124 of the cylinder 128 can apply pressure on an area within the piston 132. As illustrated, the area can be defined within the cylindrical cavity 208 (e.g., an end thereof) adjacent the first piston end 180. The fluid supplied by the pump 120 causes the piston 132 and the ram 212 coupled thereto to advance.

As the piston 132 and the ram 212 extend, the moveable jaws 192, 196 move toward each other in preparation for crimping, cutting, or punching a workpiece placed therebetween. As the moveable jaws 192, 196 reach the workpiece, the workpiece may resist movement by the moveable jaws 192, 196. Increased resistance to movement of the moveable jaws 192, 196, and therefore the piston 132, can cause pressure of the hydraulic fluid supplied by the pump 120 to rise. The hydraulic fluid pressure may continue to rise to increase a force applied on the workpiece by the work head 108 until the workpiece is sufficiently cut, crimped, punched, or otherwise worked upon. That is, the pressure ca increase to the threshold pressure.

Once the work piece is crimped, cut, or punched, and the piston 132 reaches an end of its stroke within the cylinder 128, hydraulic pressure of the fluid increases because the motor 116 may continue to drive the pump 120. The hydraulic pressure may continue to increase until it reaches a threshold pressure value (e.g., a first threshold pressure). The threshold pressure may be a pressure associated with completion of a crimp, a cut, or another work operation. In some examples, the hydraulic pressure within the cylinder 128 may be monitored by the sensor 156 (as shown in FIGS. 2 and 3). Once the controller 144 receives information from the sensor 156 (as shown in FIGS. 2 and 3) indicating that the pressure has reached the threshold pressure value, the controller 144 may shut off the motor 116 so as to retract the piston 132 and the ram 212 back to a desired position, such as a home or fully retracted position (as illustrated in FIG. 4). Additionally, as described below, the relief valve 176 may be automatically opened at or near the threshold pressure value to allow the piston 132 to retract.

As mentioned above, the power tool 100 includes the relief valve 176 configured to supply fluid from the fluid chamber 124 to the reservoir 140 to return the piston 132 or to act as an emergency relief valve to prevent overpressure. The relief valve 176 includes a valve body 236 and a poppet 220 (or another type of valve element such as a spool, a rotary element, etc.) configured to open and close an inlet port 224 (e.g., a first port) in the valve body 236. The valve body 236 defines a valve seat 232. The poppet 220 engages the valve seat 232 in a closed position to prevent fluid flow through the inlet port 224. The poppet 220 disengages from the valve seat 232 in an open position to allow fluid flow through the inlet port 224. In the illustrated example, the valve body 236 is received in a manifold or a pump body of the pump 120. In other examples, the poppet 220 can be received directly in the manifold or pump body. Correspondingly the inlet port 224 can be defined in the manifold or pump body. In some examples, the relief valve 176 may be configured as a pilot operated valve. The pilot operated configuration may reduce the actuation force needed to move the poppet 220 between the closed position and the open position.

The inlet port 224 may connect the relief valve 176 to the fluid chamber 124 of the cylinder 128. The relief valve 176 may include a spring 228 (or other biasing member) configured to bias the poppet 220 into a closed position (e.g., to engage a valve seat 232 defined by a valve body 236 of the relief valve 176) to prevent flow through the inlet port 224 and therefore through the relief valve 176. Additionally, the relief valve 176 may include an outlet port 240 (e.g., a second port) configured to connect the relief valve 176 to the reservoir 140. As such, moving the poppet 220 against the bias of the spring 228 causes the relief valve 176 to move into the open position, which allows fluid from the fluid chamber 124 of the cylinder 128 to enter the inlet port 224 and flow into the reservoir 140 via the outlet port 240. The poppet 220 can move to the open position when the pressure acting on the area of an end of the poppet (e.g., a flange 244) overcomes the biasing force of the spring 228.

As described above, in some examples, the relief valve 176 may be configured to automatically open to retract the work head 108 from the workpiece. For example, the fluid supplied by the pump 120 to the fluid chamber 124 may be configured to act on the poppet 220. Specifically, once the fluid supplied by the pump 120 to the fluid chamber 124 reaches a predefined cracking pressure, the fluid may exert a force on the poppet 220 that exceeds the force applied by the spring 228 on the poppet 220. Consequently, the poppet 220 is moved to an open position. Additionally, pressure of fluid in the fluid chamber 124 may be higher than pressure in the reservoir 140. As a result, hydraulic fluid can be discharged from the fluid chamber 124 through the relief valve 176 to the reservoir 140. In some examples, the predefined cracking pressure may be the threshold pressure, ensuring that the workpiece is properly crimped, cut, or punched prior to the relief valve 176 relieving pressure within the fluid chamber 124. In other examples the cracking pressure can be another pressure, such as a maximum working pressure (e.g., a second threshold pressure) to provide emergency pressure relief.

In one example, the power tool 100 includes a return spring 248 disposed in the fluid chamber 124, configured to return the piston 132 to the retracted position when the relief valve 176 is actuated. The return spring 248 is affixed to the cylinder 128 and acts on the surface of the piston 132 to bias the piston 132 in a direction that is away from the work head 108 (e.g., to retract the piston 132). For example, the return spring 248 may be coupled or otherwise affixed to the piston 132. Specifically, the return spring may be coupled to the piston 132 via a spring retainer 250. In some examples, during retraction of the piston 132, the return spring 248 may exert a force on the fluid, via rearward movement of the piston 132. In the illustrated arrangement, the return spring 248 is a tension spring. In other examples, the return spring 248 may be a compression spring.

As mentioned above, it may be desirable to have a tool where the piston is selectively returnable (e.g., retractable in the illustrated example) regardless of a status of the tool. For example, it may be advantageous to retract the piston prior to the work head contacting a workpiece, as the user may determine that a crimp, cut, or other form of work is not desired on the workpiece. In other examples, it may be advantageous to retract the piston and therefore the work head when the tool is powered off or is otherwise not receiving power from the power source.

As described above, in some examples, the second user interface 172 may allow the user to selectively open the relief valve 176, eliminating the need for a separate release or dump valve, as is used conventionally. Specifically, the second user interface 172 may be engaged (e.g., activated or moved) to selectively actuate the poppet 220 to the open position and allow fluid communication between the fluid chamber 124 and the reservoir 140. As also described above, opening the relief valve 176 allows retraction of the piston 132 and the work head 108. As described further below, in some examples, the second user interface 172 may actuate the relief valve 176, allowing the user to retract the piston 132 and therefore the work head 108, regardless of an operational status of the power tool 100.

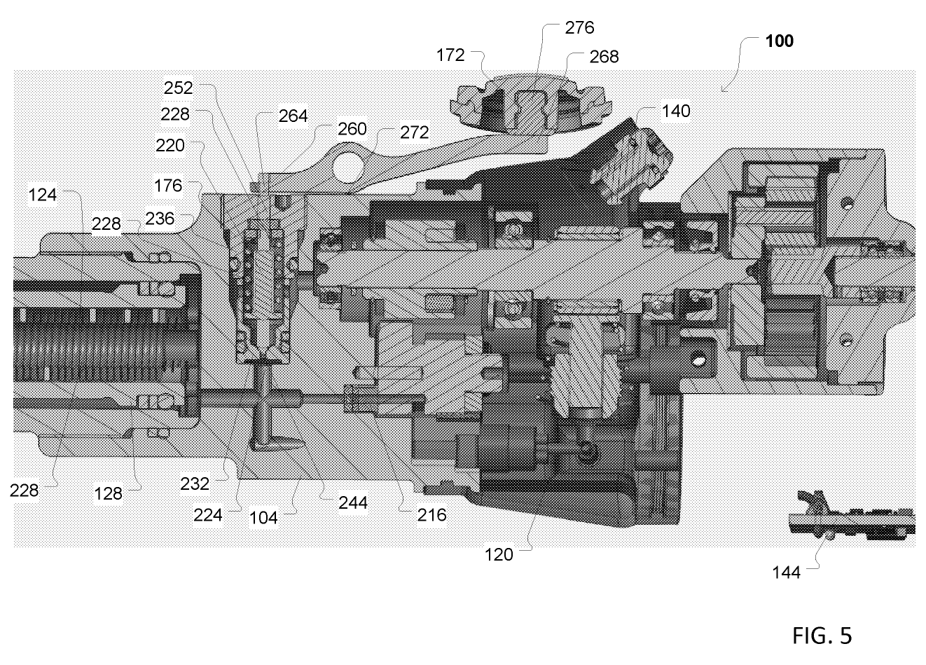

Referring specifically to FIG. 5, in some examples, the relief valve 176 may include a plunger 252 directly connected to the poppet 220. The plunger 252 can extend out of the valve body 236 to be engaged by a user to manually open the relief valve 176. In such examples, mechanically manipulating the plunger 252 may translate the poppet 220 within the relief valve 176, allowing a user to open the relief valve 176 and therefore retract the piston 132 and the work head 108. As illustrated in FIG. 5, the plunger 252 may extend from the poppet 220 allowing a user to pull or otherwise mechanically manipulate the plunger 252 to translate the poppet 220 within the relief valve 176. Specifically, the relief valve 176 may be opened by applying an external force to translate or otherwise move the plunger 252 to move the poppet 220 out of engagement with the valve seat 232. Once the plunger 252 is no longer mechanically manipulated (e.g., the external force is removed), the spring 228 may again close the relief valve 176, thus allowing hydraulic pressure to again build in the fluid chamber 124. However, in some examples, the relief valve 176 may only close if the fluid pressure acting on the poppet 220 (e.g., against the bias of the spring 228) is less than the predefined cracking pressure, as described above. The poppet 220 can move independently of the second user interface 172 when the second user interface 172 is in a disengaged position (e.g., a first position when not being activated by a user) and is retained in the open position when the second user interface 172 is in an engaged position (e.g., a second position when being activated by a user). In some examples, the second user interface 172 can be biased to the disengaged position. In this way, the poppet 220 can relief pressure independently of actuation of the second user interface 172.

Referring to FIGS. 5-9, in some examples, the poppet 220 can be mechanically manipulated (e.g., translated) by a switch, a slide, a lever, or other type of the second user interface 172. In such examples, the user may actuate the poppet 220, and therefore the relief valve 176, to the open position without the aid of the controller 144, or another electronic actuator.

Referring to FIGS. 5-7, in some examples, the plunger 252 may be moveable to the open position by the second user interface 172 that is a lever switch 256.

Referring specifically to FIG. 5, in some examples, a first lever end 260 of the lever switch 256 may be coupled to formed with a head 264 of the plunger 252. Specifically, the head 264 of the plunger 252 may be a section of the plunger 252 that extends beyond an exterior surface of the power tool 100 when the poppet 220 is in the closed configuration. Moving a second lever end 268 (e.g., pressing or pulling depending on the particular implementation) opposite the first lever end 260 may rotate the lever switch 256 about a fulcrum 272, causing the first lever end 260 to translate the plunger 252 and thus the poppet 220, consequently opening the relief valve 176. In some examples, the second lever end 268 may include a knob 276, button, or other component to allow a user to easily depress the second lever end 268 with a single finger. For example, a user may apply downward pressure to the knob 276 using their thumb or index finger. The knob 276 provides a tactile surface that facilitates user engagement. The user may press the knob 276 while gripping the housing 112 of the power tool 100 with their remaining fingers. This ergonomic arrangement allows for single-handed operation of the relief valve 176. The user may maintain pressure on the knob 276 to keep the relief valve 176 in the open position. Releasing pressure on the knob 276 allows the spring 228 to return the poppet 220 to the closed position. To that end, the lever switch 256 can be positioned to allow a user to reach both the lever switch 256 and the trigger 168 with the same hand.

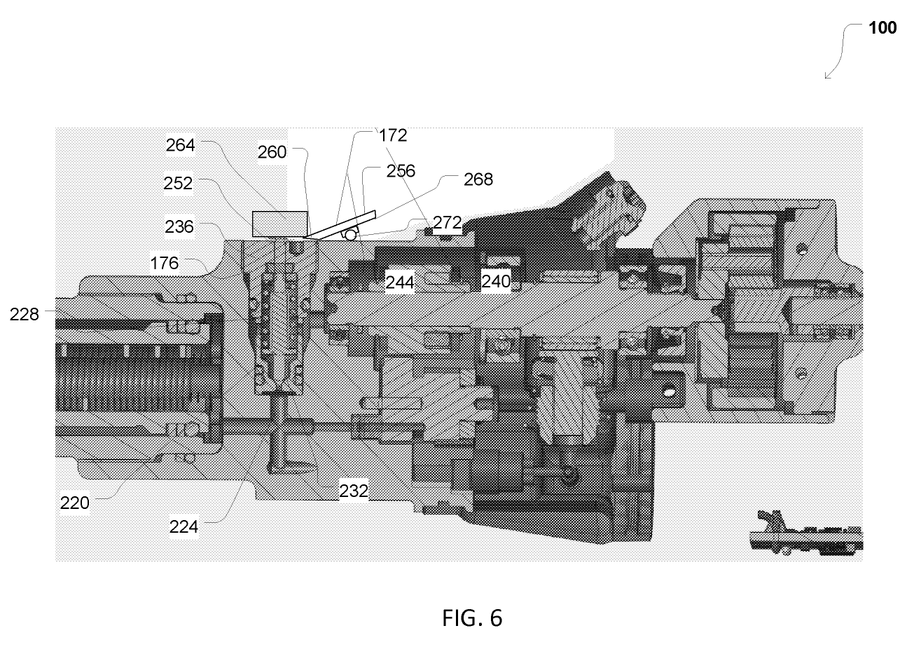

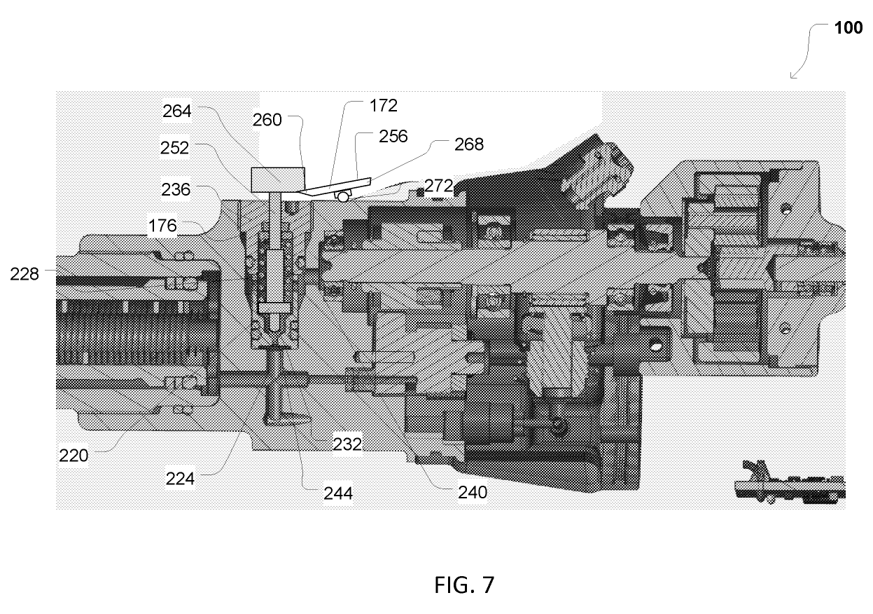

Referring to FIGS. 6-9, in some examples, the lever switch 256 may engage an exterior surface of the head 264 of the popper 220. For example, in FIGS. 6 and 7, the first lever end 260 of the lever switch 256 may be disposed underneath the head 264 of the plunger 252 (e.g., between the head 264 and the exterior of the power tool 100 or the valve body 236). Depressing a second lever end 268, opposite the first lever end 260, rotates the lever switch 256 about a fulcrum 272, causing the first lever end 260 to translate the plunger 252 and thus the poppet 220, consequently opening the relief valve 176 (see FIG. 7).

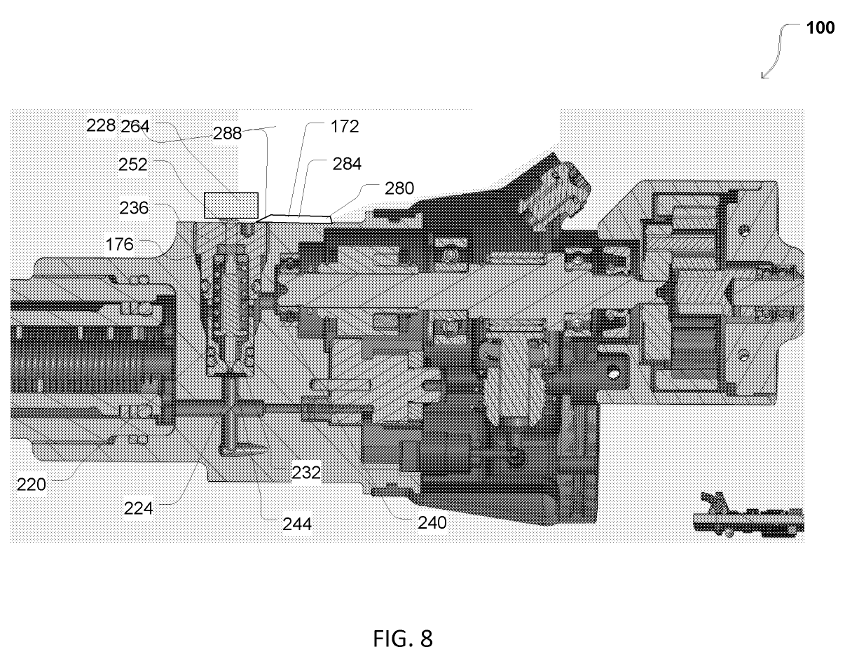

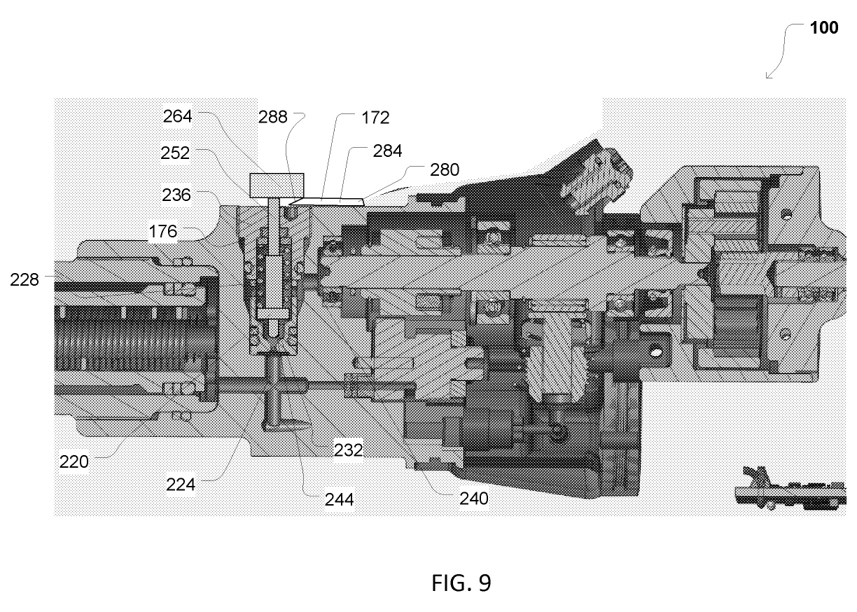

Referring to FIGS. 8 and 9, in some examples, the plunger 252 may be moveable to the open position by the second user interface 172, here configured as a sliding switch 280. For example, the user may push or pull the sliding switch 280 to engage the plunger 252 and move the poppet 220. In the illustrated example, the sliding switch 280 includes a base 284 that is engaged by a user and an extension 288. The extension 288 can extend from the base at a non-zero angle to form a ramped or cam surface that is configured to engage a head 264 of the plunger 252 to move the poppet 220. In the illustrated example, the extension 288 may initially be disposed underneath a head 264 of the plunger 252 (e.g., between the head 264 and the exterior of the power tool 100). As the extension is translated (e.g., slid) by the user toward the plunger 252 to act on the head 264, the head 264 can be moved by sliding engagement with the extension 288 to translate the plunger 252 and thus the poppet 220, consequently opening the relief valve 176 (see FIG. 9).

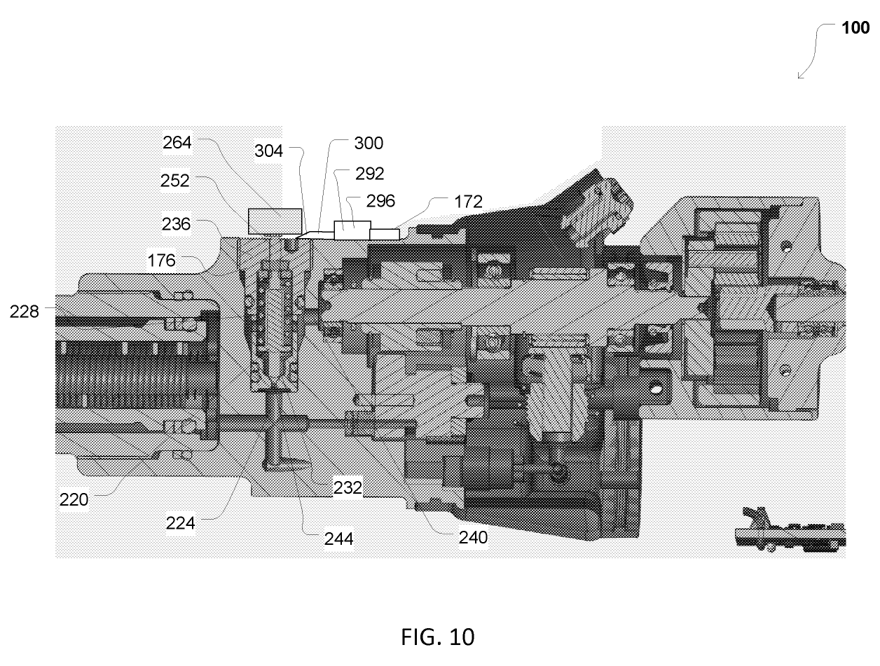

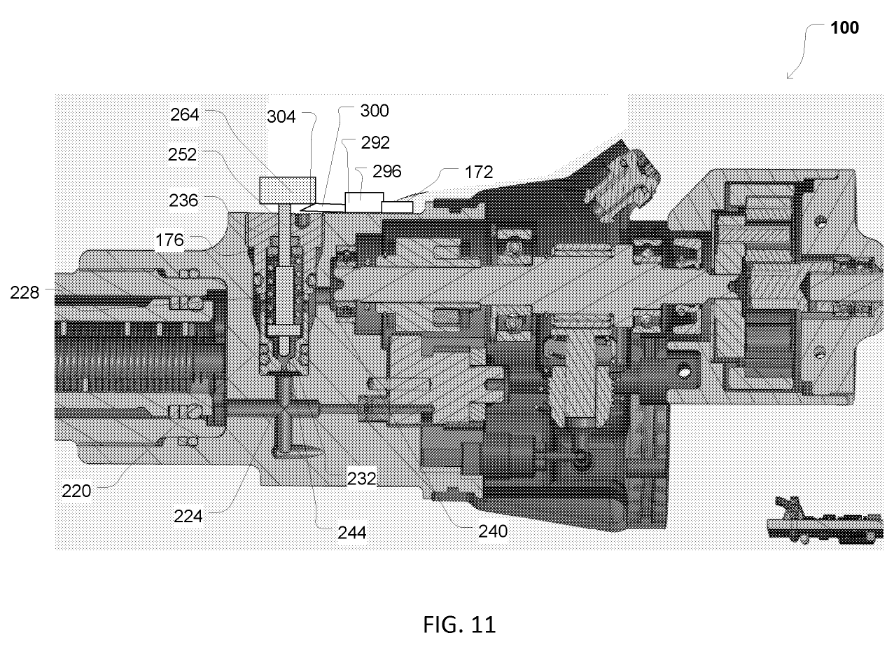

Referring to FIGS. 10 and 11, in some examples, the poppet 220 can be movable from the closed position to the open position using an electronic actuator, such as a linear actuator, a solenoid, a motor, or other type of actuator. In such examples, the second user interface 172 may be actuated to cause the controller 144 to actuate the poppet 220 utilizing the electronic actuator. The second user interface 172 can be configured as a push button that is depressed by a user to send an electrical signal to the controller 144. The controller 144 receives the signal and activates the electronic actuator 292 to open the relief valve 176. Alternatively, the second user interface 172 can be configured as a toggle switch that is flipped by a user between an off position and an on position. When the toggle switch is moved to the on position, the toggle switch sends an electrical signal to the controller 144. The controller 144 processes the signal and commands the electronic actuator 292 to translate the poppet 220 to the open position. The electronic actuator 292 can maintain the poppet 220 in the open position as long as the toggle switch remains in the on position. When the toggle switch is returned to the off position, the controller 144 deactivates the electronic actuator 292, allowing the spring 228 to return the poppet 220 to the closed position.

Referring to FIGS. 10 and 11, in some examples, the plunger 252 may be moveable to the open position using an electronic actuator 292 that is in communication with the second user interface 172 via the controller 144. For example, the user may actuate the second user interface 172 that is a button, a slider, a trigger, or other user interface to cause the electronic actuator 292 to open the poppet 220. In the illustrated example, the electronic actuator 292 may be housed within an actuator housing 296. The electronic actuator 292 (e.g., a solenoid or other line actuator) may be configured to extend and retract a base 300 also housed within the actuator housing 296. The base 300 may include an extension 304. As illustrated in FIG. 10, the extension 304 can extend from the base 300 at a non-zero angle to form a ramped surface that is configured to engage a head 264 of the plunger 252 to move the poppet 220. In the illustrated example, the extension 304 may initially be disposed underneath a head 264 of the plunger 252 (e.g., between the head 264 and the exterior of the power tool 100). As the base 300, and therefore the extension 304, is actuated (e.g., translated) by the electronic actuator 292 toward the plunger 252 to act on the head 264, the head 264 can be moved by sliding engagement with the extension 304 to translate the plunger 252 and thus the poppet 220, consequently opening the relief valve 176 (see FIG. 11).

In other examples, the relief valve 176 may itself be the electronic actuator 292, such as a solenoid. For example, the electronic actuator 292 may use electromagnetism to translate the poppet 220 within the relief valve 176. In other examples, the electronic actuator 292 may be configured to open and close the poppet 220 using a lever, or other known actuator.

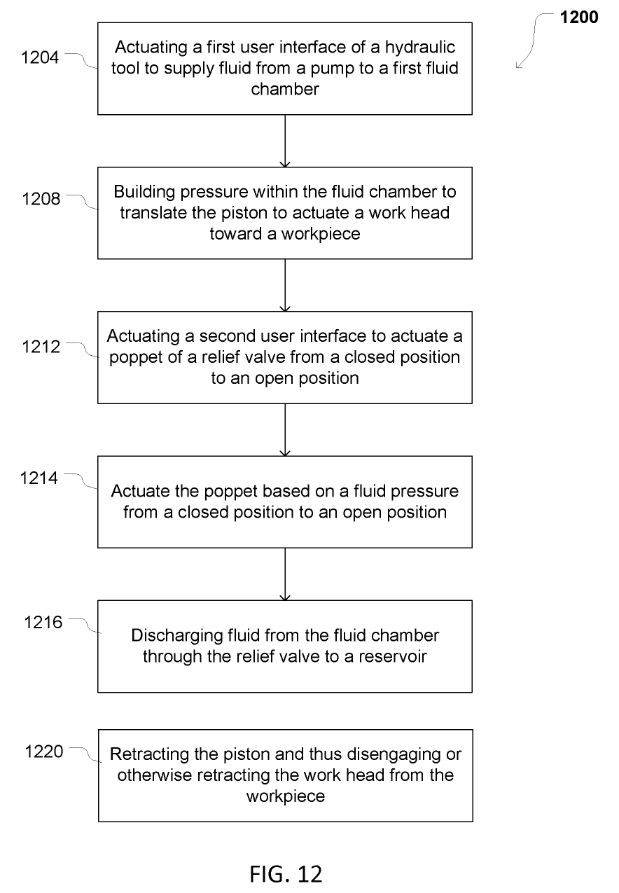

FIG. 12 shows an example method 1200 for crimping, cutting, stamping, or otherwise performing work on a workpiece using a power tool 100. Method 1200 shown in FIG. 12 presents an embodiments of methods that could be used using the hydraulic tool as shown in FIGS. 1-11, for example. Method 1200 may include one or more operations, functions, or actions as illustrated by one or more of the method steps. Also, the various steps may be combined into fewer blocks, divided into additional steps, and/or removed based upon the desired implementation.

It should be understood that for this and other processes and methods disclosed herein, flowcharts show functionality and operation of one possible implementation of present embodiments. Alternative implementations are included within the scope of the example embodiments of the present disclosure in which functions may be executed out of order from that shown or discussed, including concurrent or in reverse order, depending on the functionality involved, as would be understood by those reasonably skilled in the art.

At block 1204, the method 1200 includes actuating the first user interface 164 of the hydraulic tool to supply fluid from the pump 120 to the fluid chamber 124. The first user interface 164 may be the trigger 168 that a user depresses to initiate operation. Actuating the first user interface 164 causes the controller 144 to activate the motor 116. The motor 116 drives the pump 120 to draw fluid from the reservoir 140. The pump 120 then supplies pressurized fluid through the check valve 216 to the fluid chamber 124.

At block 1208, the method 1200 includes building pressure within the fluid chamber 124 to translate the piston 132 to actuate the work head 108 toward a workpiece. The pressurized fluid acts on the piston 132 within the cylinder 128. The fluid pressure causes the piston 132 to extend toward the work head 108. As the piston 132 extends, the ram 212 and link mechanism 188 cause the first jaw 192 and second jaw 196 to move toward one another. The jaws 192, 196 approach the workpiece positioned therebetween. When the jaws 192, 196 contact the workpiece, resistance increases and pressure within the fluid chamber 124 continues to build.

At block 1212, the method 1200 includes actuating the second user interface 172 to actuate the poppet 220 of the relief valve 176 from a closed position to an open position. The second user interface 172 may be manually actuated by a user independent of the pressure in the fluid chamber 124. This manual actuation capability allows the poppet 220 to be opened regardless of whether the pressure in the cylinder 128 has reached the predefined cracking pressure. The poppet 220 can thus be opened at any pressure level within the cylinder 128, including low pressure conditions where the relief valve 176 would not automatically open. The second user interface 172 may be the lever switch 256, the sliding switch 280, or another user interface that applies force to the plunger 252. Actuating the second user interface 172 moves the poppet 220 away from the valve seat 232 against the bias of the spring 228. This manual override function provides the user with control over pressure relief timing, independent of the hydraulic pressure conditions within the cylinder 128.

At block 1214, the method 1200 includes actuating the poppet 220 of the relief valve 176 from a closed position to an open position based on a pressure in the cylinder 128. The poppet 220 automatically moves to the open position when fluid pressure within the cylinder 128 reaches the predefined cracking pressure. The fluid pressure acts on the flange 244 of the poppet 220. When the pressure force exceeds the biasing force of the spring 228, the poppet 220 disengages from the valve seat 232. This automatic actuation occurs upon completion of a work operation when the piston 132 reaches the end of its stroke and pressure continues to build. The relief valve 176 thus provides automatic pressure relief to prevent overpressure conditions within the cylinder 128. The automatic opening allows the work head 108 to disengage from the workpiece without requiring user intervention.

The spring 228 may have a pre-load that corresponds to the predefined cracking pressure of the relief valve 176. The pre-load represents the initial compression force applied to the spring 228 when the relief valve 176 is assembled. This pre-load determines the threshold pressure at which the relief valve 176 automatically opens. The spring 228 may be compressed to a predetermined length during assembly to establish the desired pre-load force. The pre-load force acts on the poppet 220 to maintain engagement with the valve seat 232 until fluid pressure overcomes this force. When fluid pressure acting on the flange 244 exceeds the pre-load force of the spring 228, the poppet 220 moves away from the valve seat 232. The pre-load may be calibrated to correspond to a specific pressure value, such as a maximum working pressure or a pressure associated with completion of a work operation. In some cases, the pre-load may be adjustable through mechanical means to allow for different cracking pressure settings. The spring 228 may be selected based on its spring constant and compressed length to achieve the desired pre-load force that corresponds to the target cracking pressure.

At block 1218, the method 1200 includes discharging fluid from the fluid chamber 124 through the relief valve 176 to the reservoir 140. With the poppet 220 in the open position, fluid communication is established between the inlet port 224 and the outlet port 240. Pressurized fluid flows from the fluid chamber 124 through the inlet port 224, past the disengaged poppet 220, and out through the outlet port 240 to the reservoir 140.

At block 1220, the method 1200 includes retracting the piston 132 and thus disengaging or otherwise retracting the work head 108 from the workpiece. As fluid drains from the fluid chamber 124, pressure within the fluid chamber 124 decreases. The return spring 248 acts on the piston 132 to bias the piston 132 away from the work head 108. The piston 132 retracts within the cylinder 128, causing the ram 212 and link mechanism 188 to move the first jaw 192 and second jaw 196 away from one another. The work head 108 disengages from the workpiece, completing the retraction sequence.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Accordingly, the invention is capable of other embodiments and of being practiced or of being carried out in various ways. The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Additionally, unless otherwise specified or limited, the terms “about” and “approximately,” as used herein with respect to a reference value, refer to variations from the reference value of ± 15% or less, inclusive of the endpoints of the range. Similarly, the term “substantially equal” (and the like) as used herein with respect to a reference value refers to variations from the reference value of less than ± 30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

What is claimed is:

1. A power tool comprising:
a cylinder;
a piston movable within the cylinder to define a fluid chamber within the cylinder;
a reservoir to store a fluid;
a motor that is operable to drive a pump to supply the fluid from the reservoir to the fluid chamber to extend the piston;
a relief valve that opens based on a pressure in the fluid chamber to allow fluid to drain from the fluid chamber to the reservoir, the relief valve configured to open when a pressure in the fluid chamber reaches at predefined cracking pressure; and
a first user interface that is manually actuatable to open the relief valve independent of the pressure in the fluid chamber being at the predefined cracking pressure.

2. The power tool of claim 1, wherein the relief valve is positioned along a passageway that extends between the fluid chamber and the reservoir.

3. The power tool of claim 1, wherein the relief valve includes a poppet that moves between a closed position where the poppet is engaged with a seat defined in a valve body and an open position where the poppet is disengaged from the seat.

4. The power tool of claim 3, wherein the poppet is biased to the closed position by a spring, the spring having a pre-load corresponding to the predefined cracking pressure.

5. The power tool of claim 3, wherein actuation of the first user interface causes the poppet to move from the closed position to an open position.

6. The power tool of claim 3, wherein the first user interface is one of a switch, a slider, or a lever that applies an external force to the poppet.

7. The power tool of claim 1 further comprising:
a pump coupled between the reservoir and the cylinder; and
a second user interface that is manually actuatable to cause the pump to supply fluid from the reservoir to fluid chamber in the cylinder to move the piston.

8. The power tool of claim 7, wherein the first user interface and the second user interface are arranged for single-handed operation of the power tool.

9. The power tool of claim 7, wherein the poppet is positioned in the pump.

10. The power tool of claim 9, wherein the poppet is disposed in a valve body that is positioned in the pump.

11. The power tool of claim 1, wherein the second user interface is a head of the poppet.

12. The power tool of claim 1, wherein the popper includes a head and the second user interface engages the head.

13. A dual-actuated relief valve, the relief valve comprising:
a valve body defining a port;
a valve element movable within the valve body between an open position where the valve element blocks the port and a closed position where the valve element opens the port;
a biasing element biasing the valve element to the closed position and configured to allow the valve element to move to the open position based on a fluid pressure acting on the valve element; and
a user interface coupled to the valve element to allow a user to manually move the valve element from the closed position to the open position.

14. The relief valve of claim 13, wherein the valve element is a poppet that engage with a seat in the valve body in the closed position and disengages from the seat in the open position.

15. The relief valve of claim 13, wherein the user interface is a mechanical actuator that is moved by the user.

16. The relief valve of claim 13, wherein the user interface is an electronic actuator.

17. A method of operating a relief valve in a power tool, the method comprising:
providing a relief valve having a valve element movable between a closed position and an open position within a valve body;
biasing the valve element toward the closed position with a biasing element;
moving the valve element from the closed position to the open position when fluid pressure acting on the valve element reaches a predefined cracking pressure; and
actuating a first user interface to move the valve element from the closed position to the open position independent of the fluid pressure reaching the predefined cracking pressure.

18. The method of claim 17, wherein actuating the first user interface includes applying an external force to a plunger connected to the valve element.

19. The method of claim 17, further comprising actuating a second user interface to operate a pump to supply fluid from a reservoir to a cylinder when the relief valve is in the closed position.

20. The method of claim 19, further comprising discharging fluid through the relief valve when the valve element is in the open position to reduce pressure in a fluid chamber of the power tool.
